(19) United States
(12) Patent Application Publication
(10) Pub. No.: US 2026/0126313 A1
(43) Pub. Date: May 7, 2026

(54) METHOD FOR OPERATING AN ULTRASONIC FLOWMETER AND CORRESPONDING ULTRASONIC FLOWMETER

(71) Applicant: KROHNE AG, Basel (CH)

(72) Inventors: Willemijn SCHIPPER, Papendrecht (NL); Eugene VAN DIJK, Spijkenisse (NL)

(73) Assignee: KROHNE AG, Basel (CH)

(21) Appl. No.: 19/381,527

(22) Filed: Nov. 6, 2025

(30) Foreign Application Priority Data
Nov. 6, 2024 (DE) 10 2024 132 307.8

(51) Int. Cl. G01F 1/667; G01F 1/66

(52) U.S. Cl. CPC G01F 1/667; G01F 1/662

(57) ABSTRACT

A method for operating an ultrasonic flowmeter for measuring a flow through a measuring tube. A control and evaluation unit controls the emitting ultrasonic transducer such that it emits the ultrasonic signal. A receiving ultrasonic transducer receives the emitted ultrasonic signal and the control and evaluation unit in the measuring operation by evaluating emitted and received ultrasonic signals. At least one indirect value for the flow rate of the medium through the measuring tube is determined from a determined signal transit time of the ultrasonic signal. The method can react flexibly to changing measurement conditions in that the control and evaluation unit controls the emitting ultrasonic transducer such that a broadband ultrasonic signal is emitted. An optimum measuring frequency range is determined in an evaluation step. The received broadband ultrasonic signal is frequency filtered into a plurality of measuring frequency ranges of the received broadband ultrasonic signal.

This nonprovisional application claims priority under 35 U.S.C. § 119(a) to German Patent Application No. 10 2024 132 307.8, which was filed in Germany on Nov. 6, 2024, and which is herein incorporated by reference.

### BACKGROUND OF THE INVENTION

### Field of the Invention

The present invention relates to a method for operating an ultrasonic flowmeter for measuring the flow through a measuring tube through which a medium flows, wherein the ultrasonic flowmeter comprises at least one emitting ultrasonic transducer for emitting ultrasonic signals and at least one receiving ultrasonic transducer for receiving ultrasonic signals and a control and evaluation unit, wherein the ultrasonic transducers are arranged such that they implement an ultrasonic measuring path in the medium and wherein the control and evaluation unit controls the emitting ultrasonic transducer such that it emits the ultrasonic signal, the receiving ultrasonic transducer receives the emitted signal and, during measurement operation, the control and evaluation unit determines at least one indirect value for the flow rate of the medium through the measuring tube by evaluating emitted and received ultrasonic signals from a determined signal transit time of the ultrasonic signal. The invention also relates to such an ultrasonic flowmeter.

### Description of the Background Art

Flow measurement using ultrasonic waves is known. Regardless of which measuring method is used (e.g. transit time measurement, transit time difference measurement (with and against the direction of flow), frequency measurement/Doppler effect), the flow measurement is always based on the entrainment of ultrasonic waves in the medium flowing through the measuring tube, the flow velocity of which is to be determined. The (average) flow velocity of the medium along the ultrasonic measuring path can be determined from the signal propagation time of the ultrasonic signal, and thus indirectly the flow rate of the medium through the measuring tube.

Usually, the emitting ultrasonic transducers are excited with a very narrow band, preferably with a single determined frequency. This has advantages in terms of energy use (eigenvalues of piezo actuators/sensors in the ultrasonic transducer) and in signal evaluation. By selecting a certain frequency, it is also possible to specifically influence the shape and attenuation of the transmitted ultrasonic signal, for example.

This approach is problematic, for example, if there is a change in the boundary conditions under which the determined frequency was selected, for example, the sound velocity of the medium.

### SUMMARY OF THE INVENTION

It is therefore an object of the present invention to further develop the method of operating an ultrasonic flowmeter and to provide an ultrasonic flowmeter such that it can react robustly to changing operating conditions during measurement.

In an example, the object is initially achieved by the control and evaluation unit controlling the emitting ultrasonic transducer to emit a broadband ultrasonic signal.

In an evaluation step, an optimum measuring frequency range is determined by frequency-filtering the received broadband ultrasonic signal into several measuring frequency ranges of the received broadband ultrasonic signal. In the evaluation step, at least one quality value is also calculated for several of the measuring frequency ranges from the frequency-filtered ultrasonic signal of the associated measuring frequency range, and the measuring frequency range that achieves the highest quality value is determined as the optimum measuring frequency range.

This process step makes it clear what is meant by a broadband ultrasonic signal. In any case, the broadband ultrasonic signal must have frequency components over a certain frequency range, whether continuously distributed or distributed by ranges, so that the claimed frequency-filtering into several measurement frequency ranges is reasonably possible, i.e. frequency components can be present in the investigated ranges.

When determining the at least indirect value for the flow rate, i.e. in normal measurement operation, a signal transit time is used that has been determined from the optimum measuring frequency range after frequency filtering of the received broadband ultrasonic signal.

A broadband ultrasonic signal may therefore be always used, both in the evaluation step, in which the optimum measuring frequency range is determined, and in normal measurement operation, in which the broadband ultrasonic signal is frequency-filtered to the optimum measuring frequency range and the signal transit time is then determined from the frequency-filtered ultrasonic signal. By consistently working with a broadband ultrasonic signal, the transmitted ultrasonic signal should always contain a suitable frequency that is advantageous even if the measurement conditions change. Such changed measurement conditions are not responded to by an altered ultrasonic signal emitted by the emitting ultrasonic transducer, but only by an adapted frequency filtering of the received broadband ultrasonic signal, because the optimum measuring frequency range has changed.

According to a favorable design of the method, it is provided that the evaluation step for determining an optimum measuring frequency range is carried out each time the at least indirect value for the flow rate of the medium is determined. This is the quickest way to react to changing measurement conditions, but the effort involved in terms of hardware (e.g. several frequency filters), computing time and thus energy is considerable, which can be a problem, especially with two-wire devices. In an alternative design of the method, it is therefore provided that the evaluation step for determining an optimum measuring frequency range is carried out after a plurality of determinations of the at least indirect value for the flow rate of the medium or that the evaluation step for determining an optimum measuring frequency range is triggered by an external signal of the ultrasonic flowmeter. This means that large evaluation intervals can also be implemented or the evaluation step can be triggered as needed, for example, if there is a reason to suspect (changed process parameters) that the measurement situation has changed.

There are various ways to generate the broadband ultrasonic signal. In one variation, a pulse-shaped signal is generated (as close as possible to a Dirac impulse for the corresponding frequency spectrum and its subsequent evaluation). In a preferred variation of the method, the broadband ultrasonic signal is generated by exciting the emitting ultrasonic transducer with a superposition of several periodic time signals of different frequencies, in particular wherein the periodic time signals are harmonic signals. This method is advantageous because, in particular, harmonic periodic time signals can be generated very easily and, by selecting these periodic time signals, the measuring frequency ranges and the signal amplitudes in the measuring frequency ranges can also be defined.

The broadband ultrasonic signal may be generated by exciting the emitting ultrasonic transducer with a square-wave signal or with a periodic square-wave signal sequence, in particular wherein the fundamental frequency of the periodic square-wave signal sequence corresponds to a fundamental mode of an oscillation of the emitting ultrasonic transducer. This type of excitation is also easy to implement and frequency components are automatically generated at the odd multiples of the frequency of the periodic square-wave signal.

The received broadband ultrasonic signal may be frequency filtered into a plurality of measurement frequency ranges of the received broadband ultrasonic signal by using at least one analog or one digital bandpass filter. If only one bandpass filter is used, it must be possible to configure its center frequency so that the multiple measurement frequency ranges can be examined in the evaluation step in chronological succession with successive broadband ultrasonic signals. If the signal processing is implemented digitally, i.e. as a sampling system, as is the case when using modern digital signal processors, for example, then it is advantageous to implement the bandpass filter as a finite impulse response (FIR) or an infinite impulse response (IIR) filter. In an alternative design the bandpass filter is implemented as a frequency domain filter using the Fourier transform.

Various types of quality values and/or types of determination of a quality value for a measuring frequency range from the respective frequency-filtered ultrasonic signal of the associated measuring frequency range have proven to be meaningful and therefore suitable.

The quality value for a measurement frequency range can be determined by determining a signal transit time of the frequency-filtered ultrasonic signal and a transit time deviation from a comparison transit time, wherein a smaller transit time deviation corresponds to a higher quality value. Depending on the application, the comparison transit time can be obtained in different ways. For example, the comparison time can be a signal transit time from a predetermined measurement frequency range or the comparison time is determined as the average of signal transit times from predetermined measurement frequency ranges, for example from higher-frequency measurement frequency ranges, because smaller signal transit time differences are expected here. However, it may also be advantageous to calculate the average of signal transit times from all measurement frequency ranges as the comparison time.

The quality value for a frequency range of the received broadband ultrasound signal can be determined by calculating a signal deviation in the observed time interval, namely between the received, frequency-filtered broadband ultrasound signal and a corresponding reference signal, wherein a smaller signal deviation corresponds to a higher quality value. This criterion is therefore based on the similarity of the signal shape. It has proven to be advantageous to use concise points in the signal curves for the comparison in the time interval under consideration, for example, maximum deflections in the case of harmonic signals, in other words, the points of the signal curves that would span an envelope curve. In this context, it makes sense to calculate the signal deviation by comparing corresponding oscillation amplitudes.

The quality value for a frequency range of the received broadband ultrasound signal can be determined by calculating at least one frequency deviation in the observed time interval, namely between the received, frequency-filtered broadband ultrasound signal and a corresponding reference signal, wherein a smaller frequency deviation corresponds to a higher quality value. To do this, it is necessary to perform a frequency analysis of the frequency-filtered ultrasonic signal in the time interval under consideration. In a preferred design of the method, it has proven useful to calculate the present signal frequencies of the signals compared with each other in the time domain by applying the Hilbert transform to the signals, in particular wherein the quality value is the mean value of a plurality of the calculated frequency deviations in the time interval under consideration.

The quality value for a frequency range of the received broadband ultrasound signal can be determined by calculating at least one signal-to-noise ratio of the received broadband ultrasound signal in the considered time interval, wherein a larger signal-to-noise ratio corresponds to a higher quality value. In an advantageous implementation of the method, the signal-to-noise ratio is calculated from the peak-to-peak value of the pure noise signal and the peak-to-peak value of the noisy useful signal in the time interval under consideration.

The object is also achieved, in an example, by the ultrasonic flowmeter described above, whose control and evaluation unit is designed so that the ultrasonic flowmeter is able to carry out the method described above during operation.

In detail, there are now a multitude of possibilities for designing and further developing the method of operating an ultrasonic flowmeter according to the invention and the corresponding ultrasonic flowmeter. In this regard, reference is made, on the one hand, to the patent claims subordinate to the independent patent claims and, on the other hand, to the following description of embodiments in connection with the drawing.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically, a method for operating an ultrasonic flowmeter and an ultrasonic flowmeter that performs this method,

FIG. 2 shows schematically, a method for operating an ultrasonic flowmeter in which a quality value is determined from a broadband ultrasonic signal and an optimum measuring frequency range is determined from this,

FIG. 3 shows schematically, a method for operating an ultrasonic flowmeter in which a quality value is determined based on a signal transit time of the frequency-filtered ultrasonic signal,

FIG. 4 shows schematically, a method for operating an ultrasonic flowmeter in which a quality value is determined based on a signal deviation in the observed time interval between the received, frequency-filtered broadband ultrasonic signal and a corresponding reference signal,

FIG. 5 shows schematically, a method for operating an ultrasonic flowmeter in which a quality value is determined by calculating a frequency deviation in the observed time interval between the received, frequency-filtered broadband ultrasonic signal and a corresponding reference signal, and

FIG. 6 shows schematically, a method for operating an ultrasonic flowmeter in which a quality value is determined by calculating at least a signal-to-noise ratio of the received broadband ultrasonic signal in the time interval under consideration.

### DETAILED DESCRIPTION

The figures schematically show various aspects of method 1 for operating an ultrasonic flowmeter 2 and of ultrasonic flowmeters 2 that operate method 1.

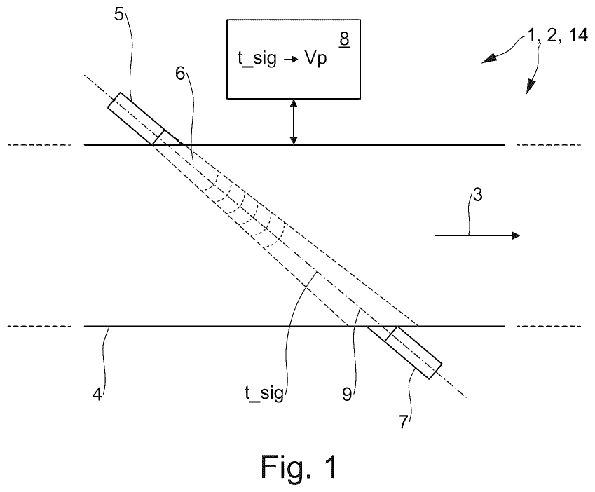

FIG. 1 shows a method 1 that relates to the measuring operation 14 of an ultrasonic flowmeter 2, in which a flow rate Vp of a medium 3 flowing through a measuring tube 4 of the ultrasonic flowmeter 2 is determined. The ultrasonic flowmeter 2 has an emitting ultrasonic transducer 5 for emitting ultrasonic signals 6 and a receiving ultrasonic transducer 7 for receiving ultrasonic signals 6, as well as a control and evaluation unit 8. The ultrasonic transducers 5, 7 are arranged in such a way that they implement an ultrasonic measuring path 9 in the medium 3. The control and evaluation unit 8 controls the emitting ultrasonic transducer 5 so that it emits the ultrasonic signal 6, the receiving ultrasonic transducer 7 receives the emitted ultrasonic signal 6 and the control and evaluation unit 8 determines the value for the flow rate Vp of the medium 3 through the measuring tube 4 from a determined signal transit time t_sig of the ultrasonic signal 6 in the measuring operation 14 shown here by evaluating emitted and received ultrasonic signals 6.

For the reasons stated in the general description, the ultrasonic signal 6 is excited in a very narrow band or even at only one frequency. The excitation frequency is then selected, for example, in dependence on the properties of the medium, the sound velocity in the medium, the frequency-dependent attenuation of ultrasonic signals in the medium, etc., and is fixed. This approach is inflexible with regard to a significant change in the measurement conditions, for example due to a change in the medium and an associated change in the sound velocity in the medium, which can have a significant influence on the measurement, in particular the quality of the measurement.

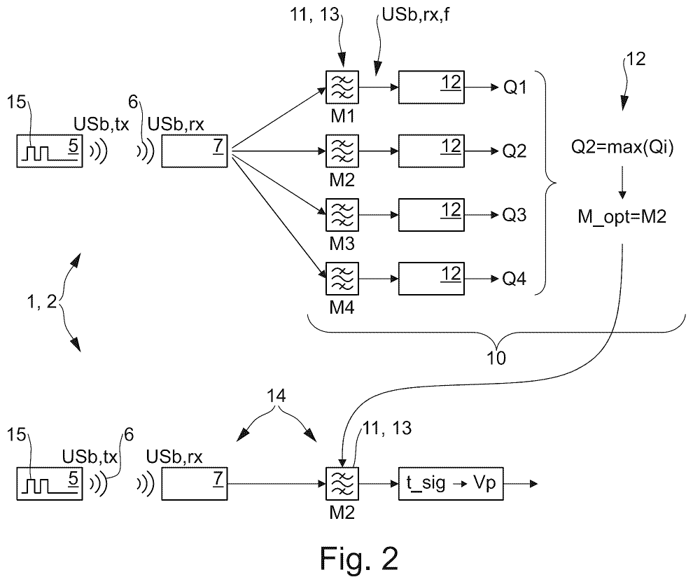

FIGS. 2 to 6 show method 1 for operating an ultrasonic flowmeter 2 and corresponding ultrasonic flowmeters 2 that enable a flexible and robust response to changing measurement conditions, thus maintaining the quality of the measurement.

The methods 1 and ultrasonic flowmeters 2 shown have in common that the control and evaluation unit 8 controls the emitting ultrasonic transducer 5 in such a way that a broadband ultrasonic signal USb,tx is emitted (FIG. 2).

In an evaluation step 10, an optimum measuring frequency range M_opt is determined by frequency-filtering 11 the received broadband ultrasonic signal USb,rx into several measuring frequency ranges M1-M4 of the received broadband ultrasonic signal USb,rx. For several of the measuring frequency ranges—in the illustrated case for all measuring frequency ranges M1-M4—a quality value Q1-Q4 is calculated in each case from the frequency-filtered ultrasonic signal USb,rx,f of the associated measuring 12. Of course, several quality values can also be calculated 12 from the frequency-filtered ultrasonic signal USb,rx,f of the associated measuring frequency range M1-M4. The measurement frequency range M that achieves the highest quality value Q is determined as the optimum measurement frequency range M_opt. In the illustrated embodiment, this is the quality value Q2=max(Qi), so that the corresponding measurement frequency range M2 is the optimum measurement frequency range M_opt.

When determining the value for the flow rate Vp, a signal transit time t_sig is then used in measurement operation 14 (lower section in FIG. 2) that has been determined from the optimum measurement frequency range M_opt=M2 after frequency filtering 11 of the received broadband ultrasonic signal USb,rx. A transmitted broadband ultrasonic signal USb,tx is therefore used throughout, so that a broadband ultrasonic signal USb,rx is always received. This applies to the evaluation step 10 as well as to the measurement operation 14. If the optimum measuring frequency range M_opt has been found, then of course only this single frequency filtering 11 needs to be carried out in the measurement operation 14.

In the method 1 and ultrasonic flowmeter 2 shown in FIG. 2, a plurality of flow measurements are carried out during measurement operation 14 after the evaluation step 10 to determine the optimum measuring frequency range M_opt. In other variations of method 1, which are not shown here, the evaluation step 10 is carried out for each flow measurement in measurement operation 14, which is relatively expensive and places high demands on the signal processing.

The signal processing in FIG. 2 is done digitally. The received broadband ultrasonic signal USb,rx is sampled at high frequency and the multitude of samples is then into the measurement frequency ranges M1-M4 11. A separate bandpass filter 13 is implemented for each measurement frequency range M1-M4, so that the frequency filtering 11 can take place simultaneously. The bandpass filters 13 are implemented as finite impulse response (FIR) filters. The method is implemented quickly due to the parallel execution of the bandpass filters 13, but it is also complex in terms of the hardware.

In an example, only a single bandpass filter 13 may be used, whose center frequency can be adjusted in the measurement frequency ranges (M1-M4) to be covered. The frequency filtering 11 into the various measurement frequency ranges M1-M4 must then be carried out sequentially, as must the associated calculation of the quality values Q1-Q4. Either received ultrasonic signals USb,rx are used sequentially one after the other, or a sampled broadband received ultrasonic signal USb,rx is stored and processed multiple times in succession. This implementation is more time-consuming, but is significantly simpler in terms of the device technology, especially since only a single bandpass filter 13 is required for frequency filtering 11 in measurement operation 14, namely for frequency filtering 11 in the optimum measurement frequency range M_opt.

In the method 1 according to FIG. 2, the broadband ultrasonic signal USb,tx is generated by exciting the emitting ultrasonic transducer 5 with a periodic square-wave signal sequence 15, wherein the fundamental frequency of the periodic square-wave signal sequence 15 corresponds to a fundamental mode of an oscillation of the emitting ultrasonic transducer 5. The ultrasonic signal 6 generated in this way contains frequency components with odd multiples of the fundamental frequency of the periodic square-wave signal sequence 15 and is thus clearly broadband.

In designs of method 1 not shown here, the broadband ultrasonic signal USb,tx is generated by exciting the emitting ultrasonic transducer 5 with a superposition of several periodic time signals of different frequencies, preferably with harmonic signals. The method is easy to implement and signals with defined frequencies can be generated with amplitudes that can be determined independently of one another.

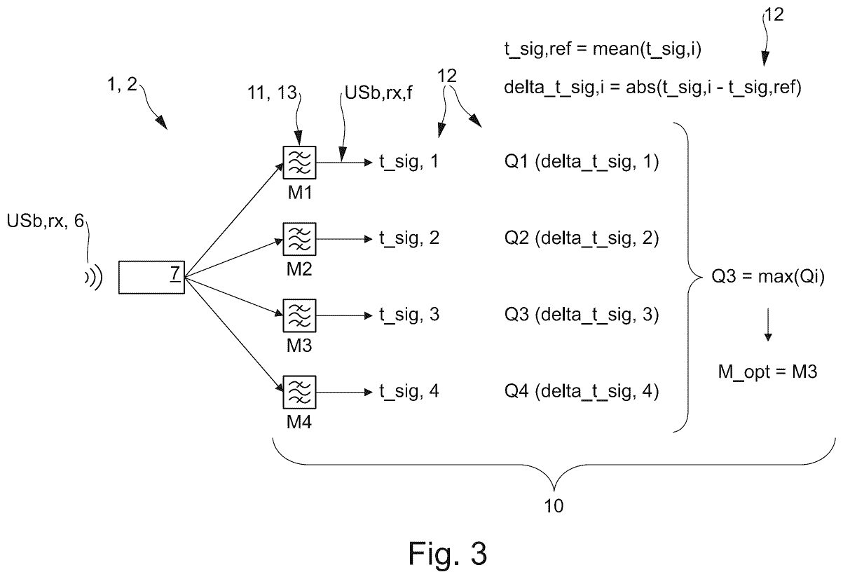

FIG. 3 shows a method 1 and an ultrasonic flowmeter 2 in which the quality value Q for a measuring frequency range M is determined by determining a signal transit time t_sig,i (for i=1 . . . 4) of the frequency-filtered ultrasonic signal USb,rx,f and a transit time deviation delta_t_sig,i from a comparison transit time t_sig,ref is determined, wherein a smaller transit time deviation delta_t_sig,i corresponds to a higher quality value Qi. In the present case, the comparison time t_sig,ref is calculated as the mean value mean(t_sig,i) of signal propagation times t_sig,i from all measurement frequency ranges M1-M4. In the illustrated case, the quality value Q3 of the measurement frequency range M3 is the greatest of all quality values Q, so that M3 is the optimum measurement frequency range M_opt.

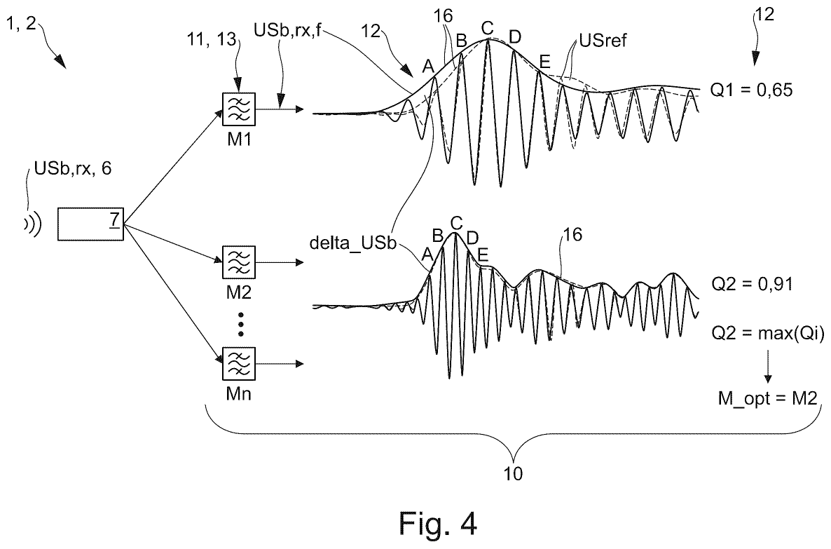

FIG. 4 shows a method 1 in which the quality value Q for a measurement frequency range M of the received broadband ultrasonic signal USb,rx is determined by calculating a signal deviation delta_USb in the time interval under consideration, namely between the received, frequency-filtered broadband ultrasonic signal USb,rx,f (solid line) and a corresponding reference signal USref (dashed line), wherein a smaller signal deviation delta_USb corresponds to a higher quality value Q. The curves of the reference signal USref were recorded here during the calibration of the ultrasonic flowmeter 2 at the factory under controlled reference conditions.

The corresponding curves are shown for the two measuring frequency ranges M1 and M2: on the one hand, the frequency-filtered 11 curves with several oscillations in the observed time domain and, on the other hand, the corresponding envelope curves 16 of the higher-frequency curves mentioned first.

The quality values Q1 and Q2 have been calculated using a signal deviation delta_USb by comparing corresponding oscillation amplitudes A, B, C, D and E of the received, frequency-filtered broadband ultrasonic signal USb,rx,f (solid line) and the corresponding reference signal USref (dashed line). In the illustrated case, the quality value Q is calculated for each measurement frequency range (M1, M2) according to the following equation:

$$Q = 1 - {\sum }_{i = 1}^{n} abs ( \frac{ampl , i ( USb , rx , f )}{max ( USb , rx , f )} - \frac{ampl , i ( USref )}{max ( USref )} )$$

n amplitudes are considered (A, B, C, D, E) and the respective curves of the received, frequency-filtered broadband ultrasonic signal USb,rx,f and the corresponding reference signal USref are normalized to their maximum deflections. The greater the deviations, the smaller the calculated quality value Q in the respective measurement frequency range M.

In the measuring frequency range M1, the amplitude values labeled A, B, C, D, E are 0.508, 0.840, 1.00, 0.865 and 0.587 for the received, frequency-filtered broadband ultrasonic signal USb,rx,f and for the corresponding reference signal USref 0.308, 0.725, 1.00, 0.864 and 0.561. This results in the quality value Q1 of 0.65.

In the measuring frequency range M2, the amplitude values labeled A, B, C, D, E are 0.430, 0.843, 1.00, 0.766 and 0.554 for the received, frequency-filtered broadband ultrasonic signal USb,rx,f and for the corresponding reference signal USref 0.397, 0.828, 1.00, 0.756 and 0.526. This results in the quality value Q2 of 0.91.

A large number of mathematical evaluation measures are conceivable for quantitatively determining the similarity of the signal forms. One example of a further measure is the deviation of the envelope curves shown in FIG. 4 between the received ultrasonic signal USb,rx,f and the reference signal USref (difference area). Other classes of measures may be correlations or statistical distance measures.

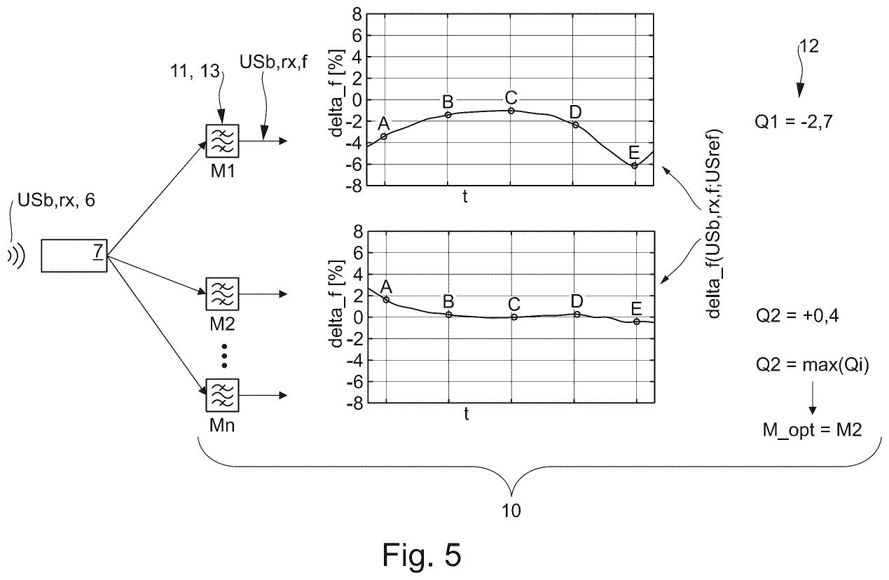

The method 1 and ultrasonic flowmeter 2 shown in FIG. 5 are characterized in that the quality value Q for a measuring frequency range M of the received broadband and frequency-filtered 11 ultrasonic signal USb,rx,f is determined by calculating a frequency deviation in the considered time interval between the received, frequency-filtered, broadband ultrasonic signal USb,rx,f and a corresponding reference signal USref, wherein a smaller frequency deviation delta_f corresponds to a higher quality value Q. The reference signal USref has been recorded, as already described for FIG. 4, under reference conditions during the factory calibration of the ultrasonic flowmeter 2. FIG. 5 does not show the various frequencies for the received, frequency-filtered broadband ultrasonic signal USb,rx,f and the corresponding reference signal USref, but rather the frequency deviations delta_f, which have been calculated at various points in time k=A, B, C, D, E of the signal curves in accordance with the following equation:

$$delta\_f , k = ( freq , k ( USref ) - freq , k ( USb , rx , f ) ) / freq , k ( USref )$$

The quality value Qi in the measurement frequency range Mi has been calculated as the mean value of the calculated instantaneous frequency deviations delta_f,k, wherein k runs through all frequency deviations:

$$Qi = mean ( delta\_f , k ( M i ) ) .$$

For the displayed frequency deviations delta_f in the measurement frequency ranges M1 and M2, a quality value of Q1=−2.7 is obtained for the measurement frequency range M1, and for the displayed frequency deviations delta_f, a quality value of Q2=+0.4 is obtained for the measurement frequency range M2. Therefore, in this example, the measurement frequency range M2 is the optimum measurement frequency range M_opt. The present signal frequencies of the compared signals in the time domain at times A, B, C, D, E are calculated by applying the Hilbert transform to the signals USb,rx,f and USref.

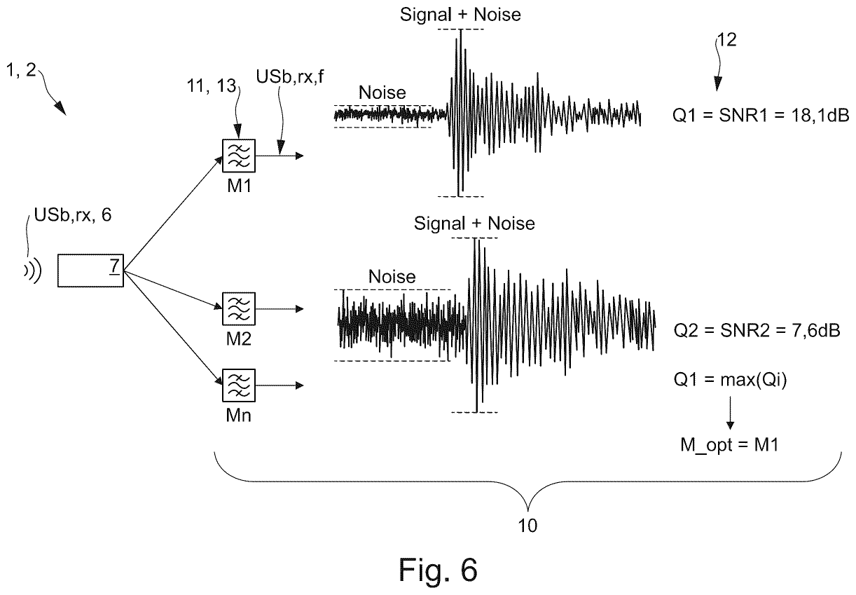

Finally, FIG. 6 shows the calculation of a further quality value Q. In FIG. 6, the quality value Q is determined for a frequency range M of the received broadband ultrasound signal USb,rx by calculating a signal-to-noise ratio SNR of the received broadband and frequency-filtered ultrasound signal USb,rx,f in the time interval under consideration, wherein a larger signal-to-noise ratio SNR corresponds to a higher quality value Q.

In the illustrated example, method 1 can be carried out in such a way that the signal-to-noise ratio SNR is calculated from the peak-to-peak value of the pure noise signal (Noise) and the peak-to-peak value of the noisy useful signal (Signal+Noise) in the time interval under consideration, according to the following equation:

$$SNRi = 20 * log 10 ( ampl ( Signal + Noise ) / ampl ( Noise ) ) ( dB ) .$$

In the conditions shown, the quality value Q1=18.1 dB is obtained in frequency range M1 and the quality value Q2=7.6 dB is obtained in frequency range 2. It follows that the frequency range M1 is the optimum measurement frequency range M_opt.

In a further development of method 1 and the corresponding ultrasonic flowmeter 2, several types of the presented quality values Q are determined and evaluated to determine the optimum measuring frequency range M_opt.

Preferably, a lower acceptance threshold is defined for each type of quality value Q (transit time, signal similarity, frequency deviation, signal-to-noise ratio), and if the value falls below this threshold, an associated measuring frequency range M categorically fails as an optimum measuring frequency range M_opt. This prevents the quality criteria Q from falling below a minimum value.

If two quality values Q of the same type are considered to be equivalent within a tolerance range at different measurement frequency ranges M, a further type of quality value in the measurement frequency ranges M is used to decide on the optimum measurement frequency range M_opt.

Preferably, an upper acceptance threshold can be defined for each type of quality value Q (transit time, signal similarity, frequency deviation, signal-to-noise ratio), and if this upper acceptance threshold is exceeded, the associated measurement frequency range M is categorically selected as the optimum measurement frequency range. This makes it possible for quality criteria Q that are used to eliminate other types of quality values Q in the event of an outstanding evaluation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an ultrasonic flowmeter to measure a flow through a measuring tube through which a medium is adapted to flow, the ultrasonic flowmeter comprising at least one emitting ultrasonic transducer to emit ultrasonic signals and at least one receiving ultrasonic transducer to receive ultrasonic signals, and comprising a control and evaluation unit, the ultrasonic transducers being arranged such that they implement an ultrasonic measuring path in the medium, the method comprising:
controlling, via the control and evaluation unit, the emitting ultrasonic transducer such that it is adapted to emit the ultrasonic signal;
receiving, via the receiving ultrasonic transducer, the emitted ultrasonic signal;
determining, via the control and evaluation unit, at least one indirect value for the flow rate of the medium through the measuring tube from a determined signal transit time of the ultrasonic signal by evaluating emitted and received ultrasonic signals during a measurement operation;
controlling, via the control and evaluation unit, the emitting ultrasonic transducer such that a broadband ultrasonic signal is emitted;
determining, in an evaluation step, an optimum measuring frequency range by frequency filtering the received broadband ultrasonic signal into a plurality of measuring frequency ranges of the received broadband ultrasonic signal;
calculating at least one quality value from the frequency-filtered ultrasonic signal of the associated measuring frequency range for a plurality of the measuring frequency ranges;
determining a measuring frequency range that achieves a highest quality value as the optimum measuring frequency range; and
using, when the at least indirect value for the flow rate is determined, a signal transit time that has been determined from the optimum measurement frequency range after frequency filtering of the received broadband ultrasonic signal.

2. The method according to claim 1, wherein the evaluation step for determining an optimum measuring frequency range is performed each time the at least indirect value for the flow rate of the medium is determined, or wherein the evaluation step for determining an optimum measuring frequency range is performed after a plurality of determinations of the at least indirect value for the flow rate of the medium, or wherein the evaluation step for determining an optimum measuring frequency range is triggered by an external signal of the ultrasonic flowmeter.

3. The method according to claim 1, wherein the broadband ultrasonic signal is generated by exciting the emitting ultrasonic transducer with a superposition of a plurality of periodic time signals, the periodic time signals having different frequencies or the periodic time signals are harmonic signals.

4. The method according to claim 1, wherein the broadband ultrasonic signal is generated by exciting the emitting ultrasonic transducer with a square-wave signal or with a periodic square-wave signal sequence, or wherein the fundamental frequency of the periodic square-wave signal sequence corresponds to a fundamental mode of an oscillation of the emitting ultrasonic transducer.

5. The method according to claim 1, wherein the received broadband ultrasonic signal is frequency filtered into a plurality of measuring frequency ranges of the received broadband ultrasonic signal by using at least one analog or digital bandpass filter, or wherein the digital bandpass filter is implemented as a finite impulse response or as an infinite impulse response filter or the bandpass filter is implemented as a frequency domain filter using the Fourier transform.

6. The method according to claim 1, wherein the quality value for a measurement frequency range is determined in that a signal transit time of the frequency-filtered ultrasonic signal is determined and a transit time deviation from a comparison transit time is determined, and wherein a smaller transit time deviation corresponds to a higher quality value.

7. The method according to claim 6, wherein the comparison transit time is a signal transit time from a predetermined measurement frequency range or the comparison transit time is the mean value of signal transit times from predetermined measurement frequency ranges or is the mean value of signal transit times from all measurement frequency ranges.

8. The method according to claim 1, wherein the quality value for a measurement frequency range of the received broadband ultrasonic signal is determined by calculating a signal deviation in the considered time interval between the received, frequency-filtered broadband ultrasonic signal and a corresponding reference signal, and wherein a smaller signal deviation corresponds to a higher quality value.

9. The method according to claim 8, wherein the signal deviation is calculated by comparing corresponding oscillation amplitudes.

10. The method according to claim 1, wherein the quality value for a measurement frequency range of the received broadband ultrasonic signal is determined by calculating at least one frequency deviation in the considered time interval between the received, frequency-filtered broadband ultrasonic signal and a corresponding reference signal, and wherein a smaller frequency deviation corresponds to a higher quality value.

11. The method according to claim 10, wherein the present signal frequencies of the signals compared with one another are calculated in the time domain by applying the Hilbert transform to the signals, or wherein the quality value is a mean value of a plurality of the calculated frequency deviations in the time interval under consideration.

12. The method according to claim 1, wherein the quality value for a frequency range of the received broadband ultrasonic signal is determined by calculating at least one signal-to-noise ratio of the received broadband ultrasound signal in the time interval under consideration, wherein a larger signal-to-noise ratio corresponds to a higher quality value.

13. The method according to claim 12, wherein the signal-to-noise ratio is calculated from the peak-to-peak value of the pure noise signal and the peak-to-peak value of the noisy useful signal.

14. An ultrasonic flowmeter comprising:
a measuring tube to measure a flow through the measuring tube through which a medium is adapted to flow;
at least one emitting ultrasonic transducer to emit ultrasonic signals;
at least one receiving ultrasonic transducer to receive ultrasonic signals; and
a control and evaluation unit,
wherein the at least one emitting and receiving ultrasonic transducers are arranged such that they implement an ultrasonic measuring path in the medium,
wherein the control and evaluation unit controls the emitting ultrasonic transducer such that it emits the ultrasonic signal, the receiving ultrasonic transducer and the control and evaluation unit determines at least one indirect value for the flow rate of the medium through the measuring tube from a determined signal transit time of the ultrasonic signal during a measurement operation by evaluating emitted and received ultrasonic signals,
wherein the control and evaluation unit controls the emitting ultrasonic transducer such that a broadband ultrasonic signal is emitted,
wherein the control and evaluation unit determines an optimum measuring frequency range in an evaluation step by frequency filtering the received broadband ultrasonic signal into a plurality of measuring frequency ranges of the received broadband ultrasonic signal by further calculating at least one quality value for a plurality of the measuring frequency ranges from the frequency-filtered ultrasonic signal of the associated measuring frequency range and by determining that measuring frequency range as the optimum measuring frequency range that achieves the highest quality value, and
wherein, when the at least indirect value for the flow rate is determined, use is made of a signal transit time which has been determined from the optimum measuring frequency range after frequency filtering of the received broadband ultrasonic signal.

15. The ultrasonic flowmeter according to claim 14, wherein the control and evaluation unit carries out a method during operation of the ultrasonic flowmeter, the method comprising:
controlling, via the control and evaluation unit, the emitting ultrasonic transducer such that it is adapted to emit the ultrasonic signal;
receiving, via the receiving ultrasonic transducer, the emitted ultrasonic signal;
determining, via the control and evaluation unit, at least one indirect value for the flow rate of the medium through the measuring tube from a determined signal transit time of the ultrasonic signal by evaluating emitted and received ultrasonic signals during a measurement operation;
controlling, via the control and evaluation unit, the emitting ultrasonic transducer such that a broadband ultrasonic signal is emitted;
determining, in an evaluation step, an optimum measuring frequency range by frequency filtering the received broadband ultrasonic signal into a plurality of measuring frequency ranges of the received broadband ultrasonic signal;
calculating at least one quality value from the frequency-filtered ultrasonic signal of the associated measuring frequency range for a plurality of the measuring frequency ranges;
determining a measuring frequency range that achieves a highest quality value as the optimum measuring frequency range; and
using, when the at least indirect value for the flow rate is determined, a signal transit time that has been determined from the optimum measurement frequency range after frequency filtering of the received broadband ultrasonic signal.
